(19) United States
(12) Patent Application Publication
(10) Pub. No.: US 2024/0185196 A1
(43) Pub. Date: Jun. 6, 2024

(54) REDUCED MEMORY RESOURCES FOR PROACTIVE MONITORING OF ELECTRONIC TRANSACTIONS

(71) Applicant: Truist Bank, Charlotte, NC (US)

(72) Inventors: Louis Allin, Richmond, VA (US); Jonathan Topp, Montpelier, VA (US); Omganesh Teekaramsingh, Johns Creek, GA (US); Madhu babu Martheneni, Cumming (IN); Lenin Kumar Pagidipala, Atlanta, GA (US)

(73) Assignee: Truist Bank, Charlotte, NC (US)

(21) Appl. No.: 18/061,516

(22) Filed: Dec. 5, 2022

(51) Int. Cl. G06Q 20/10; G06Q 20/04

(52) U.S. Cl. CPC G06Q 20/108; G06Q 20/0425

(57) ABSTRACT

A remote deposit capture (RDC) monitoring tool in the form of a computerized system that can communicate with the RDC system over a network, receive RDC transaction data for RDC transactions initiated within some period of time, and create and assign to each RDC transaction, a unique identifier comprising selected items of deposit information. The system can compare the unique identifiers associated with RDC transaction data at a selected layer or component of the RDC system with the unique identifiers associated with RDC transaction data at a downstream layer or component. The system can determine, in response to the comparison of unique identifiers, that a unique identifier and corresponding RDC transaction are missing from the downstream layer or component, while storing and processing only a fraction of the total information included in the RDC transaction data received from the RDC system. When a missing RDC transaction is detected, the system can also generate a problem notification that at least identifies the missing RDC transaction.

### TECHNICAL FIELD

The present disclosure relates generally to data memory resource management, and more particularly, although not exclusively, to reducing memory resources used in proactively monitoring electronic transactions.

### BACKGROUND

Data processing, particularly when involving large data sets and multiple different systems for processing the data, can require a significant amount of computerized memory resources and processor power to execute the data processing functions. As one example, remote deposit capture (RDC) involves processing a digitized version of a scanned check or other transactional instrument. The digitized version is transmitted between different electronic systems and multiple data processing layers to complete the associated transaction. Failures can occur when the digitized version is incorrectly processed, identified, or otherwise tracked. Systems for monitoring such a data intensive process use significant memory resources. For example, multiple versions of the same transaction data may be stored and compared to identify issues that may result in failures.

Significant memory resources required for executing a large data processing system that involves communication among multiple different systems can be expensive. Moreover, memory management processes become complex as the number and complexity of memory resources increases, which involves significantly more processing power or affected data processing time.

### SUMMARY

According to one example of the present disclosure, a computerized monitoring tool for tracking RDC transactions through a RDC system may include a database, a processor communicatively coupled to the database, and memory that is communicatively coupled to the processor and includes instructions that are executable by the processor to cause the processor to perform operations. The operations may include communicating with the RDC system over a network, receiving an indication of RDC transactions initiated through the RDC system, and receiving RDC transaction data including deposit information for each RDC transaction. The operations may also include creating for each RDC transaction a unique identifier comprising selected items of deposit information extracted from the totality of RDC transaction data received for each RDC transaction, assigning each unique identifier to a corresponding RDC transaction, and storing the unique identifiers in the monitoring tool database. The operations may additionally include comparing the unique identifiers associated with RDC transaction data at a selected layer or component of the RDC system with the unique identifiers associated with RDC transaction data received at a downstream RDC system layer or component, and determining in response to the comparison of unique identifiers, that a unique identifier and corresponding RDC transaction are missing from the downstream RDC system layer or component, while storing and processing only a fraction of the total information included in the RDC transaction data received from the RDC system. The operations may further include, in response to detecting a missing RDC transaction, storing identifying information for the missing RDC transaction in the monitoring tool database, and generating a problem notification that at least identifies the missing RDC transaction.

According to another example of the present disclosure, a non-transitory computer readable medium may contain instructions that are executable by a processor to cause the processor to perform operations. The operations may include communicating with a RDC system over a network, receiving an indication of RDC transactions initiated through the RDC system, and receiving RDC transaction data including deposit information for each RDC transaction. The operations may also include creating for each RDC transaction a unique identifier comprising selected items of deposit information extracted from the totality of RDC transaction data received for each RDC transaction, assigning each unique identifier to a corresponding RDC transaction, and storing the unique identifiers in the monitoring tool database. The operations may additionally include comparing the unique identifiers associated with RDC transaction data at a selected layer or component of the RDC system with the unique identifiers associated with RDC transaction data received at a downstream RDC system layer or component, and determining in response to the comparison of unique identifiers, that a unique identifier and corresponding RDC transaction are missing from the downstream RDC system layer or component, while storing and processing only a fraction of the total information included in the RDC transaction data received from the RDC system. The operations may further include, in response to detecting a missing RDC transaction, storing identifying information for the missing RDC transaction in the monitoring tool database, and generating a problem notification that at least identifies the missing RDC transaction.

According to a further example of the present disclosure, a method of tracking RDC transactions through a RDC system using a monitoring tool may include communicating with the RDC system over a network, receiving at the monitoring tool from the RDC system, an indication of RDC transactions initiated through the RDC system, and receiving at the monitoring tool from the RDC system, RDC transaction data that includes deposit information for each RDC transaction. The method may also include creating with the monitoring tool, for each RDC transaction, a unique identifier comprising only selected items of deposit information extracted from the totality of RDC transaction data received for each RDC transaction, assigning with the monitoring tool each unique identifier to a corresponding RDC transaction, and storing the unique identifiers in the monitoring tool database. The method may additionally include comparing with the monitoring tool, the unique identifiers associated with RDC transaction data at a selected layer or component of the RDC system with the unique identifiers associated with RDC transaction data received at a downstream RDC system layer or component, and determining with the monitoring tool and in response to the comparison of unique identifiers, that a unique identifier and corresponding RDC transaction are missing from the downstream RDC system layer or component, while storing and processing only a fraction of the total information included in the RDC transaction data received from the RDC system. The method may further include, in response to detecting a missing RDC transaction by the monitoring tool, storing identifying information for the missing RDC transaction in the monitoring tool database, and generating with the monitoring tool, a problem notification that at least identifies the missing RDC transaction.

### BRIEF DESCRIPTION OF THE DRAWINGS

FIG. 1 is a schematic block diagram of a data capture system in communication with a remote data processing monitoring tool that can detect missing data using reduced memory and processor resources according to an example of the present disclosure.

FIG. 2 is a block diagram of a remote data processing monitoring tool according to one example of the present disclosure.

FIG. 3 is a flowchart of a process for monitoring and reconciling remote data transactions using reduced memory resources according to another example of the present disclosure.

FIG. 4 is another flowchart of an additional process for monitoring and reconciling remote data transactions according to another example of the present disclosure.

### DETAILED DESCRIPTION

Certain aspects and examples of the present disclosure generally relate to a computerized monitoring tool for data processing that tracks transactions processed by multiple different systems using a unique identifier associated with each transaction. Unique identifiers can be compared through different layers or stages of systems to monitor processing of the transactions and identify potential issues or avoid failures. By monitoring transactions using unique identifiers, memory resources can be reduced as only a fraction of the total amount of transaction data associated with each transaction is stored. Likewise, processor resources can be conserved because data comparison operations can be conducted using only unique identifiers rather than the totality of digitized transaction data.

Monitoring and tracking transactions using reduced memory and processor resources, reduced power requirements, and less time, can result in corrective actions occurring more quickly when processing problems or failures arise. By way of one example, a unique identifier that is not found upon a comparison of transaction data can be flagged and transaction data associated with the missing unique identifier can be outputted by a notification to appropriate personnel with guidance on locating the missing transaction or issue that caused the transaction to be missing. In addition, or alternatively, an incident ticket with information about the missing transaction or issue that caused the transaction to be missing may be outputted and may be used to indicate how the issue was resolved, to identify reoccurring process issues, or to provide more global information, including how similar issues were previously resolved.

The following illustrative examples are provided to introduce the reader to the general subject matter discussed herein, and are not intended to limit the scope of the disclosed concepts. In the following description, specific details are set forth in order to provide a thorough understanding of various implementations and examples. Various implementations may be practiced without these specific details. The figures and description are not intended to be restrictive.

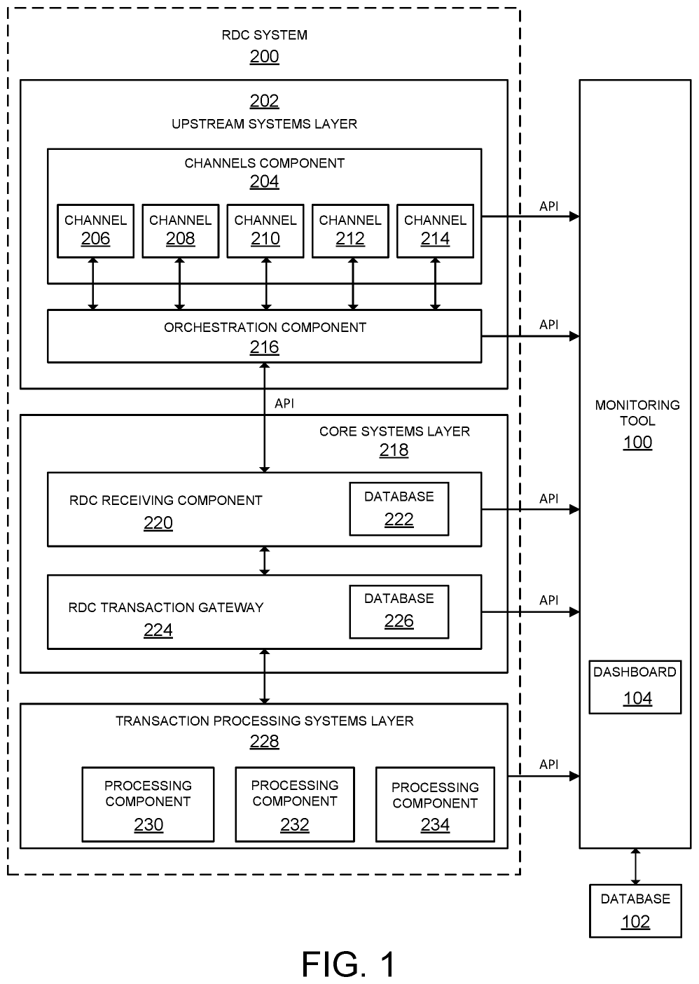

FIG. 1 is a schematic block diagram of a remote data processing monitoring tool 100 (which may also be referred to herein as “monitoring tool”) in communication over a network with a data capture system 200 according to one example of the present disclosure. In the example depicted in FIG. 1, the data capture system 200 is a remote deposit capture (RDC) system for receiving and processing RDC transactions. While the RDC system is described in detail below for purposes of illustrating the monitoring tool example and its associated operation, the monitoring tool may also be used with other data capture system implementations and examples.

As represented in FIG. 1, the remote deposit capture system 200 may include an upstream systems layer, such as the representative upstream systems layer 202. The upstream systems layer 202 may include a channels component 204, which may include multiple distinct channels 206-214 through which users can transmit both digital check image and related non-image deposit data for subsequent processing and deposit. The channels 206-214 may be, for example, cloud-based applications, mobile devices loaded with RDC applications, etc.

The upstream systems layer 202 may also include an orchestration component 216 that resides downstream of the channels component 204 and facilitates subsequent downstream transmission of RDC transaction data in the form of digital (e.g., scanned) check images and related non-image deposit data such as, without limitation, various identifying information about the deposit and the depositor. For example, when a user initiates a RDC transaction using one of the upstream systems layer channels 206-214, the utilized channel may transmit the RDC transaction data to the orchestration component 216. In at least some examples, the orchestration component 216 may store RDC transaction data in the form of log files.

The RDC system 200 example is also shown to include a core systems layer 218. The core systems layer may include a RDC transaction receiving component 220, which may be in the form of a frontend application configured to receive network-transmitted RDC transaction data from the orchestration component 216 or another downstream component of the upstream systems layer 202. The core systems layer receiving component 220 may perform various functions, such as but not limited to, digital check image assessment and balancing functions. The RDC transaction receiving component 220 may store RDC transaction data in a receiving component database 222.

The core systems layer 218 may also include a backend RDC transaction gateway 224, which may receive RDC transaction data from the RDC receiving component 220 and transmit said RDC transaction data downstream for further processing (e.g., check clearing, check depositing). More specifically, once the various processes performed by the RDC receiving component 220 complete successfully, the RDC transaction gateway 224 may generate a X9 (federal standard format) batch file that contains both check image data and non-image deposit data associated with the RDC transactions transmitted from an upstream core systems layer component such as the RDC receiving component 220. The RDC transaction gateway 224 may store RDC transaction data in a transaction gateway database 226.

Once the batch file is created by the RDC transaction gateway 224, the batch file may be transmitted to a downstream transaction processing systems layer 228. The transaction processing systems layer 228 typically processes the batch files received from the core systems layer (e.g., the RDC transaction gateway 224) of the RDC system. The transaction processing systems layer 228 may include multiple components 230, 232, 234 for performing various operations such as, for example, analysis, clearing and deposit operations.

The RDC transaction monitoring tool 100 can begin to proactively monitor and track the receipt and progress of RDC transactions through the RDC system 200 upon user initiation of a RDC transaction via a channel of the upstream systems layer 202. More specifically, the monitoring tool 100 may communicate via APIs with the components 204, 216 of the upstream systems layer 202, such that the monitoring tool 100 may be made aware of new RDC transactions and receive data associated therewith.

When the data associated new RDC transactions is received from the RDC system 200, the monitoring tool 100 may create a unique identifier for each RDC transaction, assign each unique identifier to a corresponding RDC transaction, and store the unique identifiers in the monitoring tool database. To conserve memory resources and reduce required processor power, the unique identifier may be comprised of selected items of RDC transaction (e.g., deposit) information extracted from the larger totality of RDC transaction data received for each RDC transaction. By way of example, and without limitation, a unique identifier may be a combination of only the deposit ID, date, time, and item sequence number associated with a given RDC transaction by the RDC system 200.

As described in more detail below, the unique identifiers may be used by the monitoring tool 100 to track the progress of RDC transactions through the RDC system 200 and to detect missing RDC transactions, while requiring that only a minimal amount of RDC transaction data be stored and processed. This allows the monitoring tool to operate more quickly and efficiently, and may also allow for a more cost-effective monitoring tool construction.

As depicted in FIG. 1, the monitoring tool 100 may also communicate via a respective API with the cores systems layer 218 of the RDC system 200. In the example shown, the monitoring tool 100 communicates with each of the RDC receiving component 220 and the RDC transaction gateway 224 of the RDC system core systems layer 218. This can allow the monitoring tool 100 to track the progress of RDC transactions from the upstream systems layer 202 to the core systems layer 218 of the RDC system 200, as well as through the core systems layer and to the transaction processing systems layer 228 of the RDC system.

According to one aspect of the present disclosure, the monitoring tool 100 may determine if a RDC transaction is missing from a particular layer or component of the RDC system 200. For example, the monitoring tool 100 may compare the unique identifiers associated with RDC transaction data received at a selected layer or component of the RDC system with the unique identifiers associated with RDC transaction data received at a RDC system layer or component that is downstream of the selected layer or component and determine, in response to the comparison of unique identifiers, that a unique identifier and corresponding RDC transaction are missing from the downstream RDC system layer or component. Identifying information corresponding to missing RDC transactions detected by the monitoring tool 100 may be subsequently stored in the monitoring tool database 102.

According to one example, the monitoring tool 100 may determine that a RDC transaction is missing from RDC transaction data received by the core systems layer 218 from the upstream systems layer 202. In this regard, the monitoring tool 100 may compare the unique identifiers of RDC transactions represented in the RDC transaction data at the RDC receiving component 220 of the core systems layer 218 with the unique identifiers of RDC transactions represented in the RDC transaction data at the orchestration component 216 of the upstream systems layer 202, and determine that a RDC transaction is missing at the RDC receiving component 220.

According to another example, the monitoring tool 100 may determine that a RDC transaction is missing from RDC transaction data transmitted between upstream and downstream components within the RDC system core systems layer 218. For example, in the case of the example RDC system 200 of FIG. 1, the monitoring tool 100 may compare the unique identifiers of RDC transactions represented in the RDC transaction data at the RDC transaction gateway 224 with the unique identifiers of RDC transactions represented in the RDC transaction data at the upstream RDC receiving component 220, and determine that a RDC transaction is missing at the RDC transaction gateway 224.

According to another example, the monitoring tool 100 may determine that a RDC transaction is missing from the RDC transaction data received by the transaction processing systems layer 228 from the upstream core systems layer 218 of the RDC system 200. In this regard, the monitoring tool 100 may compare the unique identifiers of RDC transactions represented in the RDC transaction data at one or more components 230, 232, 234 of the transaction processing systems layer 228 with the unique identifiers of RDC transactions represented in the RDC transaction data at the upstream RDC transaction gateway 224, and determine that a RDC transaction is missing at the transaction processing systems layer 228.

According to one data comparison aspect of the present disclosure, the monitoring tool 100 may store in the monitoring tool database as a first data set, all the unique identifiers associated with the individual RDC transactions represented in the RDC transaction data received at a selected RDC system layer or component. Similarly, the monitoring tool 100 may store in the monitoring tool database as a second data set, all the unique identifiers associated with the individual RDC transactions represented in the RDC transaction data received at another RDC system layer or component that is downstream of the selected RDC system layer or component. The data in the first and second data sets may be inserted into respective temporary tables prior to being stored.

Once the first and second data sets have been stored, the monitoring tool 100 may reconcile the data by performing a comparison operation. More specifically, the monitoring tool 100 may compare the unique identifiers in the second data set with the unique identifiers in the first data set and determine, by the comparison, that a unique identifier and corresponding RDC transaction are are missing from the second data set (and downstream RDC system layer or component).

Determining by the monitoring tool 100 that a RDC transaction is missing from a given RDC system layer or component may be time dependent. For example, because the transfer of RDC transaction data from an upstream RDC system layer or component to a downstream RDC system layer or component may not be instantaneous, the monitoring tool 100 may consider RDC transaction data missing after the downstream RDC system layer or component has not received the transaction data within some predefined amount of time subsequent to the transaction data being received by the upstream RDC system layer or component. To this end, the monitoring tool 100 may repeat the above-described comparison and determination operations multiple times within the predefined time. Terminating the comparison and determination operations may result from the first to occur of detecting the initially missing RDC transaction at the downstream RDC system layer or component, or expiration of the predefined time period or execution of a predetermined number of comparison and determination operations without detecting the missing RDC transaction.

In any case, determining by the monitoring tool that a RDC transaction is missing from a given RDC system layer or component by comparing only unique identifiers, rather than the totality of the data associated with the RDC transactions, minimizes required monitoring tool memory resources, and reduces needed processor power. Similarly, once identifying information for any detected missing RDC transactions is stored in the monitoring tool database, any already stored unique identifiers or deposit information associated therewith may be deleted from the monitoring tool database. This deletion of unique identifier or related deposit information also helps to conserve monitoring tool memory resources.

According to some examples, detecting a missing RDC transaction within the RDC system 200 may result in generating a problem notification. The problem notification may be an electronic notification that is transmitted to or otherwise viewable by or one or more personnel who are authorized to see such notifications and appropriately qualified to interact with the RDC system to correct the problem. A problem notification may include various types of information including, for example and without limitation, any RDC transaction information available from the upstream or downstream component of the RDC system core systems layer 218. A problem notification may also include information regarding possible causes of the missing RDC transaction or suggested ways to fix the problem.

At least certain monitoring tool examples may further generate an incident ticket when a missing RDC transaction is detected. The incident ticket may be electronic or otherwise but, in any case, may serve as an additional tracking tool that provides useful information about a missing RDC transaction problem and how the problem was resolved. For example, an authorized user responding to a missing RDC transaction problem may be required to close the incident ticket upon resolving the problem, which serves as evidence that the problem was resolved and when the problem was resolved. An incident ticket may also require an authorized user to describe how a missing RDC transaction problem was resolved before the incident ticket can be closed.

In at least some examples, the monitoring tool 100 may further include a dashboard 104 that provides an authorized user with secure, role-based internal access to the monitoring tool and the monitoring tool database 102, at least for the purposes of investigating a problem identified by a generated problem notification. To access the monitoring tool 100, an authorized user may log in through a user interface 112 of the monitoring tool 100 by entering secure login credentials. Once the login credentials of the user are authenticated, the user may be provided with access to the monitoring tool 100 and the monitoring tool database 102, where the user can view missing RDC transaction information, etc. The authorized user may also be able to view any RDC transaction information stored in the core systems layer of the RDC system (e.g., the RDC receiving component 220 and the RDC transaction gateway 224 of the core systems layer 218). According to least one example, the monitoring tool dashboard 104 may include channel-wise tabs that allow a user to see a dashboard specifically related to the type of upstream system layer channel from which a given missing RDC transaction emanated.

By using the information available from a problem notification or incident ticket, and by accessing the monitoring tool, an authorized user can investigate missing RDC transactions and troubleshoot and correct the problem (e.g., RDC system problem, network problem) that caused a given RDC transaction to be missing. To further conserve monitoring tool memory resources, stored identifying information associated with missing RDC transactions that are subsequently moved downstream and processed, may be deleted from the monitoring tool database 102. Deletion of data stored in the monitoring tool database 102 may occur in real time, or may occur later, such as during a regularly scheduled (e.g., daily) monitoring tool data base cleanup.

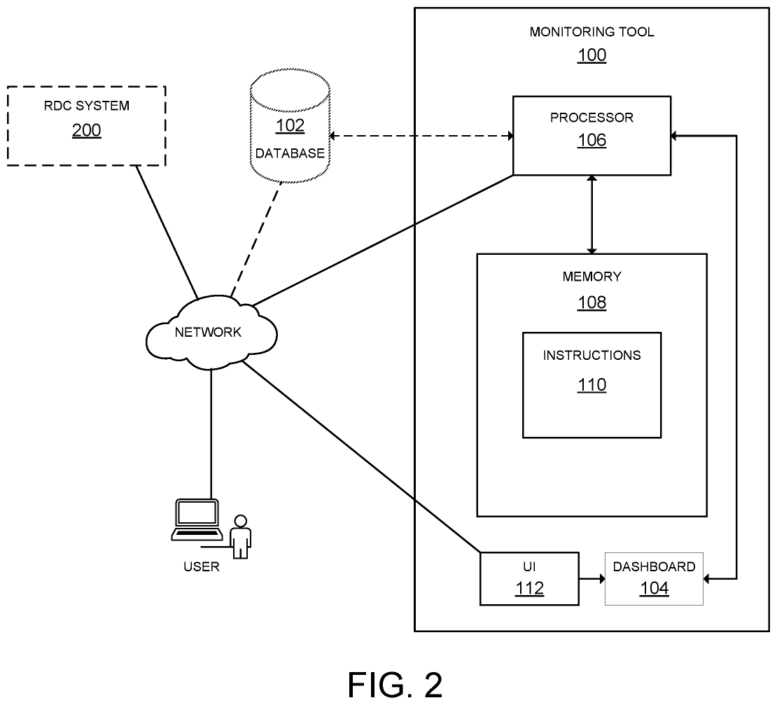

FIG. 2 is a block diagram depicting various components of one example of a data capture monitoring tool, such as the RDC transaction monitoring tool 100 described above with respect to the schematic diagram of FIG. 1. As depicted, the monitoring tool 100 may include a processor 106 that is communicatively coupled to a memory 108. The processor 106 may also be communicatively coupled to the monitoring tool database 102, which may be located remotely from the processor and in communication with the processor over a network. The processor may be further communicatively coupled to the dashboard 104, such as for permitting an authorized user to access the monitoring tool 100 and the RDC system 200 as previously described.

The processor 106 can include one processing device or multiple processing devices. Non-limiting examples of the processor 106 include a Field-Programmable Gate Array (FPGA), an application-specific integrated circuit (ASIC), a microprocessor, etc. The processor 106 can execute instructions 110 stored in the memory 108 to perform operations. In some examples, the instructions 110 can include processor-specific instructions generated by a compiler or an interpreter from code written in a suitable computer-programming language, such as C, C++, C #, etc.

The memory 108 can include one memory or multiple memories. The memory 108 can be non-volatile and may include any type of memory that retains stored information when powered off. Non-limiting examples of the memory 108 include electrically erasable and programmable read-only memory (EEPROM), flash memory, or any other type of non-volatile memory. At least some of the memory 108 can be a non-transitory computer-readable medium from which the processor 106 can read the instructions 110. A computer-readable medium can include electronic, optical, magnetic, or other storage devices capable of providing the processor 106 with computer-readable instructions or other program code. Non-limiting examples of a computer-readable medium include magnetic disk(s), memory chip(s), ROM, random-access memory (RAM), an ASIC, a configured processor, optical storage, or any other medium from which the processor 106 can read the instructions 110.

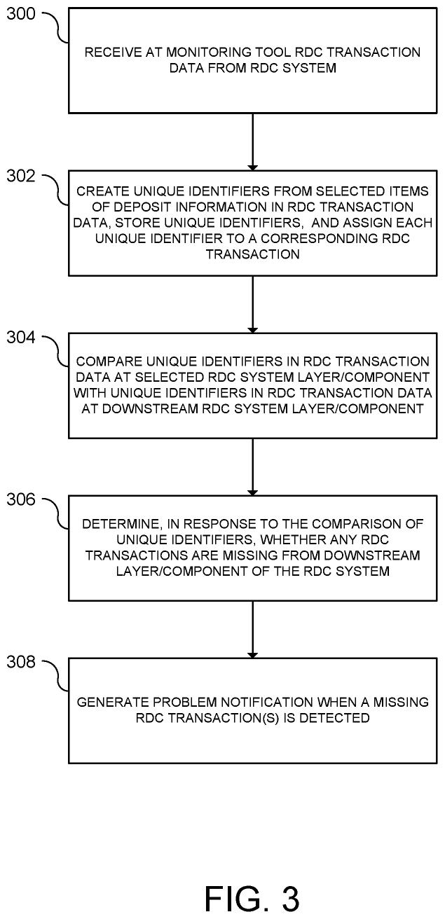

FIG. 3 is a flowchart illustrating generally a process for monitoring and reconciling electronic data transactions according to some aspects of the present disclosure. The process represented in FIG. 3 is described for purposes of illustration with respect to monitoring and reconciling RDC transactions, however, the process may also apply to monitoring and reconciling various other types of transactions.

As represented in FIG. 3, at block 300, a monitoring tool according to an example of the present disclosure may initially receive RDC transaction data from a RDC system. From selected items of deposit information of the received RDC transaction data, the monitoring tool at block 302 may create a unique identifier for each RDC transaction contained in the RDC transaction data, may assign each unique identifier to a corresponding RDC transaction, and may save the unique identifiers for later use.

At block 304, the monitoring tool may compare the unique identifiers associated with RDC transaction data received at a selected layer or component of the RDC system with the unique identifiers associated with RDC transaction data received at a RDC system layer or component that is downstream of the selected layer or component. At block 306, the monitoring tool may determine, in response to the comparison of unique identifiers, that a unique identifier and corresponding RDC transaction are missing from the downstream RDC system layer or component. The method may perform the comparison and determination operations while storing and processing only a fraction of the total information included in the RDC transaction data received from the RDC system. According to block 308, if a missing RDC transaction is detected, a problem notification may be generated.

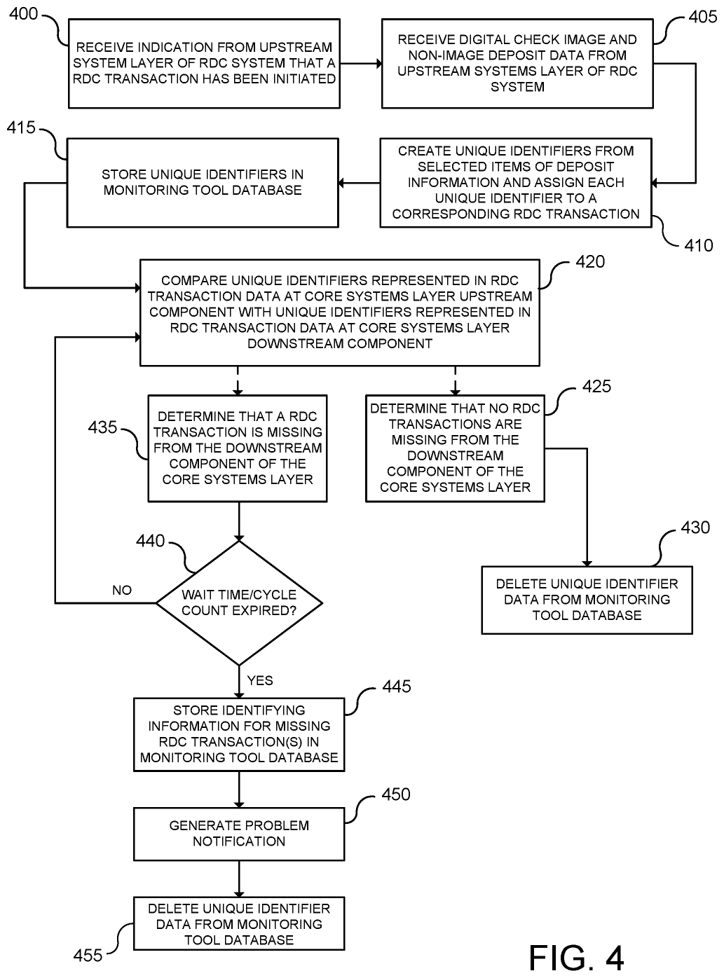

FIG. 4 is a more detailed flowchart illustrating further aspects of a process for monitoring and reconciling remote deposit capture transactions according to another example of the present disclosure. For purposes of illustration, and not limitation, the process represented in FIG. 4 is described generally with respect to the RDC system 200 example of FIG. 1 and the monitoring tool 100 example of FIG. 2, although other implementations of both are possible without departing from the scope of the present disclosure.

It can be observed that at block 400 of FIG. 4, the monitoring tool may receive indications from an upstream systems layer of a RDC system of RDC transactions that are initiated through the RDC system. At block 405, the monitoring tool may subsequently receive from the RDC system upstream systems layer a file containing a digital check image and various non-image deposit data associated with each RDC transaction. At block 410, the monitoring tool may create from selected items of deposit information in the received RDC transaction data, a unique identifier that corresponds to each RDC transaction contained in the received RDC transaction data, and may assign each unique identifier to a corresponding RDC transaction. At block 415, the unique identifiers may be stored in a monitoring tool database.

At block 420, the monitoring tool may compare the unique identifiers represented in RDC transaction data received at an upstream component (e.g., RDC receiving component 220 in FIG. 1) of the RDC system core systems layer with the unique identifiers represented in RDC transaction data received at a downstream component (e.g., RDC transaction gateway 224 in FIG. 1) of the RDC system core systems layer. At block 425, the monitoring tool may determine, in response to the comparison of unique identifiers, that no RDC transactions are missing from the downstream component of the RDC system core systems layer. If no missing RDC transactions are detected, then at block 430 the stored unique identifier data may be deleted from the monitoring tool database, and the monitoring process may be considered complete until it subsequently repeats upon receipt at the monitoring tool of the next RDC transaction data file from the upstream systems layer of the RDC system.

Alternatively, the monitoring tool may determine at block 435 that a RDC transaction is missing from the downstream component of the RDC system core systems layer. In this case, a timer or counter may be started, and the monitoring process may repeat the comparison operation at block 420. The comparison (and subsequent determination) operation may repeat until the initially missing RDC transaction(s) is found at the downstream component of the RDC system core systems layer or, as indicated by block 440, until a predefined (but selectable) time set in the timer expires, or until the comparison operation is repeated some predefined (but selectable) number of times set in the counter. Use of a timer or counter helps to ensure that enough time is allowed for RDC transaction data to be transmitted from the upstream component to the downstream component of the RDC system core systems layer before it is determined that a RDC transaction(s) is truly missing from the RDC system core systems layer downstream component.

Upon a determination that a RDC transaction(s) is missing from the downstream component of the RDC system core systems layer, the process at block 445 may store identifying information regarding the missing RDC transaction(s) in the monitoring tool database. As shown at block 450, a problem notification may then be generated. The problem notification may be sent to authorized personnel or otherwise made available for viewing by authorized personnel, for purposes of investigating and correcting the problem(s) that caused the RDC data transaction(s) to be missing from the downstream component of the RDC system core systems layer. At block 455, stored unique identifier data may be subsequently deleted from the monitoring tool database to further conserve monitoring tool memory resources.

While not shown in FIG. 4, an authorized user may subsequently log in to the monitoring tool as described above with respect to FIG. 1, and use information from the problem notification to investigate and correct the (e.g., RDC system, network) problem that caused the RDC transaction(s) to be missing from the downstream component of the RDC system core systems layer. Similarly, an incident ticket may be automatically generated when a missing RDC transaction is detected. An authorized user may also use information from the incident ticket to investigate and correct problems. The authorized user may also be required to close or otherwise interact with the incident ticket in a manner such that the incident ticket serves as an additional tracking tool, providing useful information about a missing RDC transaction problem and how the problem was resolved.

The process represented in FIG. 4 is described for purposes of illustration particularly with respect to data comparison and missing RDC transaction determination operations that take place within the RDC system core systems layer, and between an upstream component and a downstream component thereof. It should be understood, however, that similar data comparison and missing RDC transaction determination operations may also take place between other successive upstream and downstream RDC system layers and RDC system components.

As one example of further data comparison and missing RDC transaction determination operations, and referring again to FIG. 1, a data comparison and RDC transaction determination operation may also be performed relative to RDC transaction data present at the downstream component (e.g., orchestration component 216) of the upstream systems layer 202 and RDC transaction data present at the upstream component (e.g., RDC receiving component 220) of the RDC system core systems layer 218. Likewise, a similar data comparison and RDC transaction determination operation may be performed relative to RDC transaction data present at the downstream component (e.g., RDC transaction gateway 224) of the of the RDC system core systems layer 218 and one or more of the processing components 230, 232, 234 of the transaction processing systems layer 228. In other words, according to at least some aspects of the present disclosure, the RDC transaction monitoring and comparison functions of the monitoring tool are configured to detect and identify missing RDC transactions between any pair of successive upstream and downstream RDC system components.

The foregoing description of certain examples, including illustrated examples, has been presented only for purposes of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A computerized monitoring tool for tracking remote deposit capture (RDC) transactions through a RDC system having multiple data processing layers, the monitoring tool comprising:
a database;
a processor communicatively coupled to the database;
memory communicatively coupled to the processor, the memory including instructions that are executable by the processor to cause the processor to:
communicate with the RDC system over a network;
receive from the RDC system, an indication of RDC transactions initiated through the RDC system;
receive from the RDC system, RDC transaction data including deposit information for each RDC transaction;
for each RDC transaction, create a unique identifier comprising selected items of deposit information extracted from the RDC transaction data received for each RDC transaction;
assign each unique identifier to a corresponding RDC transaction;
store the unique identifiers in the database;
compare the unique identifiers associated with RDC transaction data received at a selected layer or component of the RDC system with the unique identifiers associated with RDC transaction data received at a RDC system layer or component that is downstream of the selected layer or component and determine, in response to comparing the unique identifiers, that a unique identifier and corresponding RDC transaction are missing from the downstream RDC system layer or component, while storing and processing only a fraction of the RDC transaction data received from the RDC system;
in response to determining that a RDC transaction is missing from the downstream RDC system layer or component, store identifying information for the missing RDC transaction in the database; and
generate a problem notification that at least identifies the missing RDC transaction.

2. The monitoring tool of claim 1, wherein the RDC transaction data includes both digital check image and non-image deposit data, and the memory includes instructions that are executable by the processor to cause the processor to extract the selected items of deposit information from only the non-image deposit data to conserve memory and processor resources.

3. The monitoring tool of claim 1, wherein the memory further includes instructions that are executable by the processor for causing the processor to delete unique identifiers stored in the database before receiving new RDC transaction data from the RDC system.

4. The monitoring tool of claim 1, wherein the memory further includes instructions that are executable by the processor for causing the processor to determine that a missing RDC transaction has been processed by a downstream transaction processing systems layer of the RDC system.

5. The monitoring tool of claim 4, wherein the memory further includes instructions that are executable by the processor for causing the processor to, after determining that the missing RDC transaction has been processed by the transaction processing systems layer, delete stored identifying information associated with the missing RDC transaction from the database.

6. The monitoring tool of claim 1, wherein the memory further includes instructions that are executable by the processor for causing the processor to, upon initially determining that the RDC transaction is missing from the downstream layer or component of the RDC system, repeatedly compare the unique identifiers associated with RDC transaction data received at the selected layer or component of the RDC system with the unique identifiers associated with RDC transaction data received at the downstream layer or component of the RDC system until:
the initially missing RDC transaction is found at the downstream layer or component of the RDC system;
a predefined amount of time expires; or
comparing the unique identifiers associated with RDC transaction data received at the selected layer or component of the RDC system with the unique identifiers associated with RDC transaction data received at the downstream layer or component of the RDC system is repeated some predefined number of times.

7. The monitoring tool of claim 1, wherein the memory includes instructions that are executable by the processor to cause the processor to:
store in the database as a first data set, all unique identifiers associated with the RDC transactions represented in RDC transaction data received at the selected layer or component of the RDC system;
store in the database as a second data set, all unique identifiers associated with the RDC transactions represented in RDC transaction data received at the RDC system layer or component that is downstream of the selected layer or component of the RDC system; and
compare the unique identifiers in the second data set with the unique identifiers in the first data set and determine, in response to comparing the unique identifiers, that a unique identifier and corresponding RDC transaction are missing from the second data set and the downstream RDC system layer or component.

8. The monitoring tool of claim 7, wherein the memory includes instructions that are executable by the processor for causing the processor to delete the first data set and the second data set from the database after identifying information for the missing RDC transaction is stored in the database.

9. The monitoring tool of claim 1, wherein the RDC system includes multiple distinct channels via which RDC transactions can be initiated, and the memory includes instructions that are executable by the processor for causing the processor to track a RDC transaction through the RDC system using only a unique identifier regardless of the channel through which the RDC transaction was submitted.

10. The monitoring tool of claim 1, wherein the selected layer or component of the RDC system is an upstream systems layer, and the RDC system layer or component that is downstream of the upstream systems layer is a core systems layer.

11. The monitoring tool of claim 1, wherein the selected layer or component of the RDC system and the RDC system layer or component that is downstream of the upstream systems layer are both components of a RDC system core systems layer.

12. A non-transitory computer-readable medium comprising instructions that are executable by a processor for causing the processor to:
communicate with a RDC system over a network;
receive from the RDC system, an indication of RDC transactions initiated through the RDC system;
receive from the RDC system, RDC transaction data including deposit information for each RDC transaction;
for each RDC transaction, create a unique identifier comprising selected items of deposit information extracted from the RDC transaction data received for each RDC transaction;
assign each unique identifier to a corresponding RDC transaction;
store the unique identifiers in a database;
compare the unique identifiers associated with RDC transaction data received at a selected layer or component of the RDC system with the unique identifiers associated with RDC transaction data received at a RDC system layer or component that is downstream of the selected layer or component and determine, in response to comparing the unique identifiers, that a unique identifier and corresponding RDC transaction are missing from the downstream RDC system layer or component, while storing and processing only a fraction of the RDC transaction data received from the RDC system;
in response to determining that a RDC transaction is missing from the downstream RDC system layer or component, store identifying information for the missing RDC transaction in the database; and
generate a problem notification that at least identifies the missing RDC transaction.

13. The non-transitory computer-readable medium of claim 12, wherein the RDC transaction data includes both digital check image and non-image deposit data, and the instructions of the non-transitory computer-readable medium are executable for causing the processor to extract the selected items of deposit information from only the non-image deposit data to conserve memory and processor resources.

14. The non-transitory computer-readable medium of claim 12, wherein the instructions of the non-transitory computer-readable medium are executable for causing the processor to:
determine that a missing RDC transaction has been processed by a downstream transaction processing systems layer of the RDC system; and
in response to determining that the missing RDC transaction has been processed by the transaction processing systems layer, delete stored identifying information associated with the missing RDC transaction from the database.

15. The non-transitory computer-readable medium of claim 12, wherein the instructions of the non-transitory computer-readable medium are executable for causing the processor to, upon initially determining that the RDC transaction is missing from the downstream layer or component of the RDC system, repeatedly compare the unique identifiers associated with RDC transaction data received at the selected layer or component of the RDC system with the unique identifiers associated with RDC transaction data received at the downstream layer or component of the RDC system until:
the initially missing RDC transaction is found at the downstream layer or component of the RDC system;
a predefined amount of time expires; or
comparing the unique identifiers associated with RDC transaction data received at the selected layer or component of the RDC system with the unique identifiers associated with RDC transaction data received at the downstream layer or component of the RDC system is repeated some predefined number of times.

16. A method of tracking remote deposit capture (RDC) transactions through a RDC system using a monitoring tool having a processor communicatively coupled to a memory including instructions that are executable by the processor, the method comprising:
communicating with the RDC system over a network;
receiving, at the monitoring tool from the RDC system, an indication of RDC transactions initiated through the RDC system;
receiving, at the monitoring tool from the RDC system, RDC transaction data including deposit information for each RDC transaction;
for each RDC transaction, creating by the monitoring tool, a unique identifier comprising selected items of deposit information extracted from the RDC transaction data received for each RDC transaction;
assigning, by the monitoring tool, each unique identifier to a corresponding RDC transaction;
storing the unique identifiers in a monitoring tool database;
comparing, by the monitoring tool, the unique identifiers associated with RDC transaction data received at a selected layer or component of the RDC system with the unique identifiers associated with RDC transaction data received at a RDC system layer or component that is downstream of the selected layer or component and determining, by the monitoring tool in response to comparing the unique identifiers, that a unique identifier and corresponding RDC transaction are missing from the downstream RDC system layer or component, while storing and processing only a fraction of the RDC transaction data received from the RDC system;
in response to detecting a missing RDC transaction by the monitoring tool, storing identifying information for the missing RDC transaction in the monitoring tool database; and
generating, by the monitoring tool, a problem notification that at least identifies the missing RDC transaction.

17. The method of claim 16, wherein the RDC transaction data includes both digital check image and non-image deposit data, and the selected items of deposit information are extracted from only the non-image deposit data to conserve memory and processor resources.

18. The method of claim 16, further comprising:
determining that a missing RDC transaction has been processed by a downstream transaction processing systems layer of the RDC system; and
in response to determining that the missing RDC transaction has been processed by the transaction processing systems layer, deleting stored identifying information associated with the missing RDC transaction from the monitoring tool database.

19. The method of claim 16, further comprising, upon initially determining that the RDC transaction is missing from the downstream layer or component of the RDC system, repeatedly comparing the unique identifiers associated with RDC transaction data received at the selected layer or component of the RDC system with the unique identifiers associated with RDC transaction data received at the downstream layer or component of the RDC system until:
the initially missing RDC transaction is found at the downstream layer or component of the RDC system;
a predefined amount of time expires; or
comparing the unique identifiers associated with RDC transaction data received at the selected layer or component of the RDC system with the unique identifiers associated with RDC transaction data received at the downstream layer or component of the RDC system is repeated some predefined number of times.
